(19) United States
(12) Patent Application Publication
(10) Pub. No.: US 2020/0112505 A1
(43) Pub. Date: Apr. 9, 2020

(54) FLOW RULES

(71) Applicant: Hewlett Packard Enterprise Development LP, Houston, TX (US)

(72) Inventors: Harish B Kamath, Bangalore (IN); Vijay Vishwanath Hegde, Bangalore (IN); Deepak Khungar, Bangalore (IN); Michael Lee Witkowski, Tomball, TX (US)

(21) Appl. No.: 16/150,458

(22) Filed: Oct. 3, 2018

(51) Int. Cl. H04L 12/721; H04L 12/715; H04L 12/931; H04L 12/46; H04L 12/717

(52) U.S. Cl. CPC H04L 45/38; H04L 45/64; H04L 49/70; G06F 9/45558; H04L 12/4641; H04L 45/42; H04L 45/66

(57) ABSTRACT

A method may include generating a plurality of rules corresponding to respective flows associated with a computing network. The method can further include determining, based on application of flow rules, whether data corresponding to the respective flows is to be stored by a switching sub-system of the network. In some examples, the method can include taking an action using the switching sub-system in response to the determination.

### BACKGROUND

A computing network such as a software defined network (SDN) can include resources such as processing and/or memory resources that can be spread across multiple logical components. A SDN can provide a centralized framework in which forwarding of network packets is disassociated from routing of network packets. For example, a control plane can provide centralized management of network packet routing in a SDN, while a data plane separate from the control plane can provide management of forwarding of network packets.

### BRIEF DESCRIPTION OF THE DRAWINGS

FIG. 1 illustrates a block diagram in the form of an example apparatus including a flow composer component consistent with the disclosure.

FIG. 2A illustrates a block diagram in the form of an example apparatus including a flow composer component and switching sub-system consistent with the disclosure.

FIG. 2B illustrates another block diagram in the form of an example apparatus including a flow composer component and switching sub-system consistent with the disclosure.

FIG. 2C illustrates a block diagram in the form of an example apparatus including a control plane and a flow composer component consistent with the disclosure.

FIG. 2D illustrates a block diagram in the form of an example apparatus including a control plane, a data plane, and a flow composer component consistent with the disclosure.

FIG. 3 illustrates a block diagram in the form of an example switching sub-system consistent with the disclosure.

FIG. 4 illustrates a block diagram in the form of an example system including a flow composer component, a control plane, and a plurality of virtual machines.

FIG. 5 illustrates another a block diagram in the form of an example system including a flow composer component, control planes, and a plurality of virtual machines.

FIG. 6 illustrates an example flow diagram for flow rules consistent with the disclosure.

### DETAILED DESCRIPTION

Software defined networks (SDNs) such as information technology infrastructures can include physical computing components (e.g., processing resources, network hardware components, and/or computer components, etc.) as well as memory resources that can store instructions executable by the physical computing components and/or network components to facilitate operation of the SDN. As an example, a SDN can operate as a host for collections of virtualized resources that may be spread across one or more logical components. These virtual resources may facilitate a networked relationship among each other as part of operation of the SDN.

In some approaches, the resources (e.g., the processing resources and/or memory resources) and relationships between the physical computing components can be manually created or orchestrated through execution of instructions. Such resources and relationships can be managed through one or more managed services and may be configured distinctly.

A switching sub-system may be utilized to manage networked data flows that arise from the relationships described above. Examples of switching sub-systems that allow for virtualization in a SDN can include VIRTUAL CONNECT® or other virtual network fabrics. Tasks such as discovering network resources, capturing runtime properties of the SDN, and/or facilitating high data rate transfer of information through the SDN can be provided by such switching sub-systems. However, in some approaches, manual configuration of the relationships can result in sub-optimal performance of the SDN due to their static nature in a dynamically evolving infrastructure, can be costly and/or time consuming, and/or can be prone to errors introduced during manual configuration processes. Further, in some approaches, SDN scalability may be difficult due to manual configuration of the switching sub-systems and/or relationships. This can be further exacerbated in SDNs, which can be characterized by dynamic allocation of resources and/or dynamic reconfiguration of the relationships.

In contrast, examples herein may allow for discovery and/or processing of flows in a SDN or in portions thereof. For example, discovery and/or processing of flows in a switching sub-system that is part of the SDN may be performed in accordance with the present disclosure. In some examples, network parameters and/or infrastructure parameters may be altered or reconfigured based on runtime behaviors of the SDN. In addition, network components such as switches, routers, virtual machines, hubs, processing resources, data stores, etc. may be characterized and/or dynamically assigned or allocated at runtime. Finally, in some examples, by managing flows in the SDN as described herein, the SDN may be monitored and/or managed in a more efficient way as compared to some approaches.

In a switching sub-system, data may ingress and egress at a rate on the order of Gigabits per second (Gbps). As a result, a switching sub-system can learn and/or un-learn 100s of end points over short periods of time. In a SDN, end points can exist at Layer 2 (L2), Layer 3 (L3), and higher layers of the open systems interconnection (OSI) model. Discovery of such endpoints at various layers of the OSI model and/or recognizing relationships dynamically and/or establishing contexts between endpoints may be complex, especially in SDNs in which resources and relationships may be created and/or destroyed rapidly in a dynamic manner. Further, because network packets can be stateless, identifying and/or introducing states such as L2 or L3 flows between two or more endpoints can include inspecting multiple packets (streams) and/or object vectors made up of endpoint statistics or telemetry data.

As mentioned above, workloads in a SDN can be moved around (e.g., dynamically allocated, reallocated, or destroyed), which can alter flow composition through the SDN. For example, as resources and/or relationships in a SDN are redefined or moved around, flows can be dynamically altered, rendered obsolete, or otherwise redefined. In some examples, packet priorities can be defined in packets to reduce delays or losses of flows in the SDN. As used herein, a “flow” is an object that characterizes a relationship between two endpoints in a SDN. Non-limiting examples of flows include objects that characterize a relationship between two media access control (MAC) addresses, internet protocol (IP) addresses, secure socket shells (SSHs), file transfer protocol (FTP) transport protocol ports, hypertext transfer protocols (HTTP) transport protocol ports, etc.

A flow can include properties such as a received packet count, a transmitted packet count, a count of jumbo-sized frames, and/or endpoint movement details, among other properties. In some examples, a flow may exist for an amount of time that the flow is used (e.g., flows may be dynamically generated and/or destroyed). Creation (or destruction) of flows can be based on meta data associated with packets that traverse the SDN. In some examples, flows may be monitored to enforce transmission and/or receipt rates (or limits), to ensure that certain classes of traffic are constrained to certain pathways, to ensure that certain classes of traffic are barred from certain pathways, and/or to reallocate flows in the SDN, among others.

Examples of the disclosure include apparatuses, methods, and systems related to flow rules. In some examples, a method may include generating a plurality of rules corresponding to respective flows associated with a computing network. The method can further include determining, based on application of flow rules, whether data corresponding to the respective flows is to be stored by a switching sub-system of the network. In some examples, the method can include taking an action using the switching sub-system in response to the determination.

FIG. 1 illustrates a block diagram in the form of an example apparatus 100 including a flow composer component 102 consistent with the disclosure. In FIG. 1, the apparatus 100 includes the flow composer component 102, which may be provisioned with processing resource(s) 104 and memory resource(s) 106. For example, the flow composer component 102 can access to a pool of processing resource(s) 104 and/or memory resource(s) 106 such the flow composer component 102 can ultimately execute instructions using the processing resource(s) 104 and/or the memory resource(s) 106. Accordingly, in some examples, the processing resource(s) 104 and/or the memory resource(s) 106 can be in a separate physical location (e.g., in a SDN) than the flow composer component 102. Examples are not limited to SDNs, however, and the flow composer component 102 can be provided as part of a conventional computing network or computing system. In some examples, the flow composer component 102, processing resource(s) 104, and/or the memory resource(s) 106 may be separately considered an “apparatus.”

The processing resource(s) 104 can include hardware, circuitry, and/or logic that can be configured to execute instructions (e.g., computer code, software, machine code, etc.) to perform tasks and/or functions to facilitate configuration entity ranking as described in more detail herein.

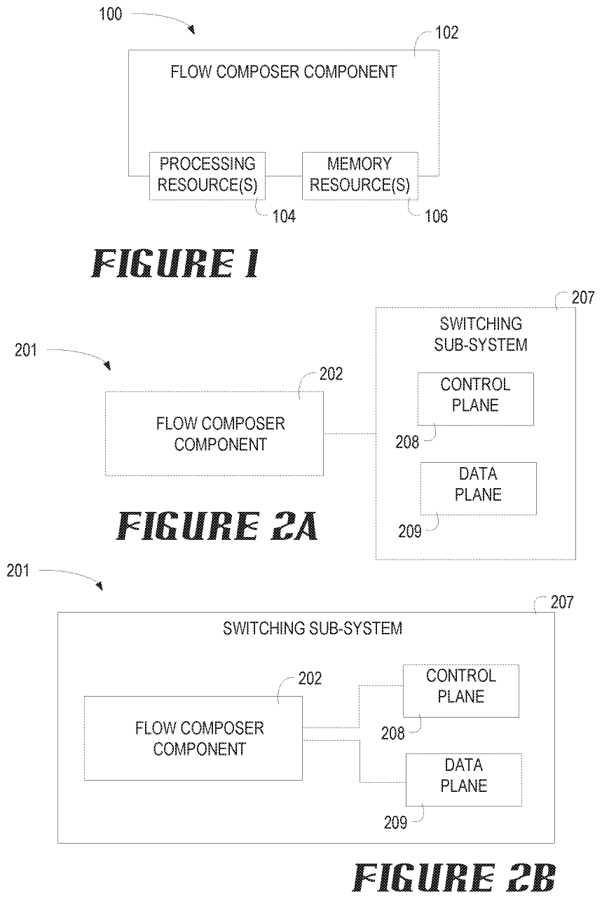

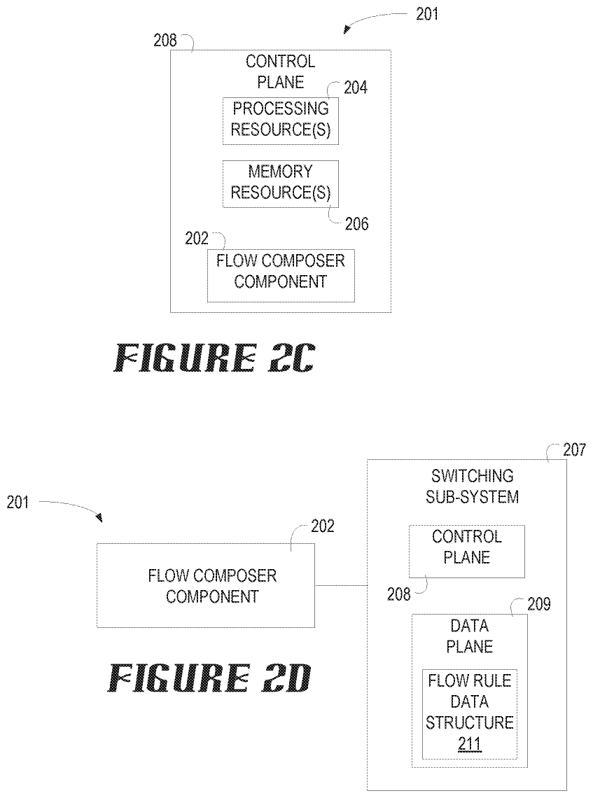

The flow composer component 102 can include hardware, circuitry, and/or logic that can be configured to execute instructions (e.g., computer code, software, machine code, etc.) to perform tasks and/or functions to generate, categorize, prioritize, and/or assign flow rules as described in more detail herein. In some examples, the flow composer component 102 can be deployed (e.g., physically disposed on) on a switching sub-system such as switching sub-system such as switching sub-system 207 illustrated in FIG. 2B, herein, or the flow composer component 102 can be deployed on a control plane such as control plane 208 illustrated in FIG. 2C, herein. Examples are not so limited, however, and in some examples the flow composer component 102 can be communicatively coupled to a switching sub-system, as shown in FIG. 2A, herein.

FIG. 2A illustrates a block diagram in the form of an example apparatus 201 including a flow composer component 202 and switching sub-system 207 consistent with the disclosure. The switching sub-system 207 can include a control plane 209 and/or a data plane 209. The switching sub-system 207 can be communicatively coupled to the flow composer component 202, as indicated by the line connecting the flow composer component 202 to the switching sub-system 207. The flow composer component 202, the switching sub-system 207, the control plane 208, and/or the data plane 209 can separately be considered an “apparatus.”

As used herein, a “control plane” can refer to, for example, a part of a switch or router architecture that is concerned with computing a network topology and/or information in a routing table that corresponds to incoming packet traffic. In some examples, the control plane functions on a central processing unit of a computing system. As used herein, a “data plane” can refer to, for example, a part of a switch or router architecture that decides what to do with packets arriving on an inbound interface. In some examples, the data plane can include a data structure (e.g., a flow rule data structure 211 illustrated in FIG. 2D, herein) that is responsible for looking up destination addresses of incoming packets and retrieving information to determine a path for the incoming packet to traverse to arrive at its destination.

In some examples, data plane 209 operations can be performed on the data structure at line rate, while control plane 208 operations can offer higher flexibility than data plane operations, but a lower rate. Entries in the data structure corresponding to the data plane 209 can be system defined and/or user defined. Examples of entries that can be stored in the data structure include exact match tables, ternary content-addressable memory tables, etc., as described in more detail in connection with FIG. 2D, herein.

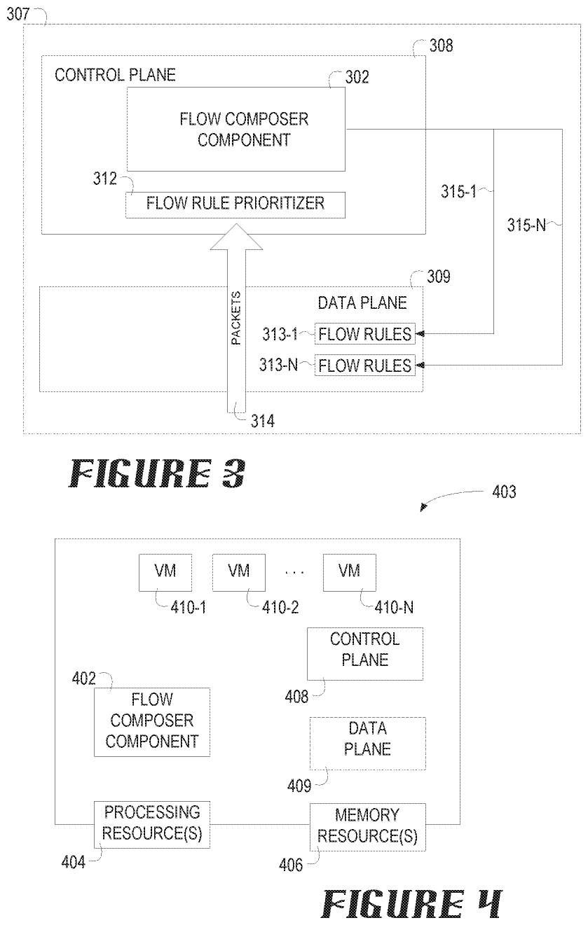

The data plane 209 can collect and/or process network packets against a set of rules. The data plane 209 can cause the network packets to be delivered to the control plane 208 at a particular time, such as at a time of flow discovery. The control plane 208 can identify and/or manage flows, as described in more detail in connection with FIG. 3, herein. In some examples, the control plane 208 can construct flow rules, deconstruct flow rules, and/or apply the flow rules into the data plane 209. In addition, the control plane 208 can perform management operations for a data structure that contains the flow rules (e.g., flow rule data structure 211 illustrated in FIG. 2D, herein). In some examples, the flow composer component 202 can perform the above operations on behalf of the control plane. For example, the flow composer component 202 can be a part of the control plane 208, as shown in FIG. 2C.

FIG. 2B illustrates another block diagram in the form of an example apparatus 201 including a flow composer component 202 and switching sub-system 207 consistent with the disclosure. The flow composer component 202, the switching sub-system 207, the control plane 208, and/or the data plane 209 can separately be considered an “apparatus.”

FIG. 2B illustrates an alternative example of the apparatus 201 of FIG. 2A in which the flow composer component 202 is included as part of the switching sub-system 207. For example, as shown in FIG. 2B, the flow composer component 202 can be deployed/tightly-coupled to the switching sub-system 207.

FIG. 2C illustrates a block diagram in the form of an example apparatus 201 including a control plane 208 and a flow composer component 202 consistent with the disclosure. The control plane 208 can include processing resource(s) 204 and/or memory resource(s) 206 in addition to the flow composer component 202. In some examples, the processing resource(s) 204 and/or the memory resource(s) 206 can be used by the flow composer component 202 to perform operations related to flow rules, as described herein. In some examples, the control plane 208, the processing resource(s) 204, the memory resource(s) 206, and/or the flow composer component 202 can be separately considered an “apparatus.”

The memory resource(s) 206 can include volatile (e.g., dynamic random-access memory, static random-access memory, etc.) memory and/or non-volatile (e.g., one-time programmable memory, hard disk(s), solid state drive(s), optical discs, etc.). In some examples, the processing resource(s) 204 can execute the instructions stored by the memory resource(s) 206 to cause the flow composer component 202 to perform operations involving flow rules, as supported by the disclosure.

FIG. 2D illustrates a block diagram in the form of an example apparatus 201 including a control plane 208, a data plane 209, and a flow composer component 202 consistent with the disclosure. The data plane 209 can include a flow rule data structure 211. In some examples, the switching sub-system 207, the control plane 208, the data plane 209, the flow rule data structure 211, and/or the flow composer component 202 can be separately considered an “apparatus.”

As used herein, a “data structure” can, for example, refer to a data organization, management, and/or storage format that can enable access and/or modification to data stored therein. A data structure can comprise a collection of data values, relationships between the data values, and/or functions that can operate on the data values. Non-limiting examples of data structures can include tables, arrays, linked lists, records, unions, graphs, trees, etc.

The flow rule data structure 211 shown in FIG. 2D can be a data structure in which flow rules (e.g., flow rules 313-1, . . . , 313-N illustrated in FIG. 3) are stored. In some examples, the flow rule data structure 211 can include one or more exact-match tables and/or ternary content-addressable memory (TCAM) tables. The flow rules stored by the flow rule data structure 211 can include rules that characterize relationships between two end points in a computing network, as described above.

For example, the flow rules can include rules defining what end points in the network are associated with different packets in the network. Example rules can include rules governing the behavior of packets associated with particular VLANs, source MAC addresses, destination MAC addresses, internet protocols, transmission control protocols, etc., as described in more detail in connection with FIG. 3, herein.

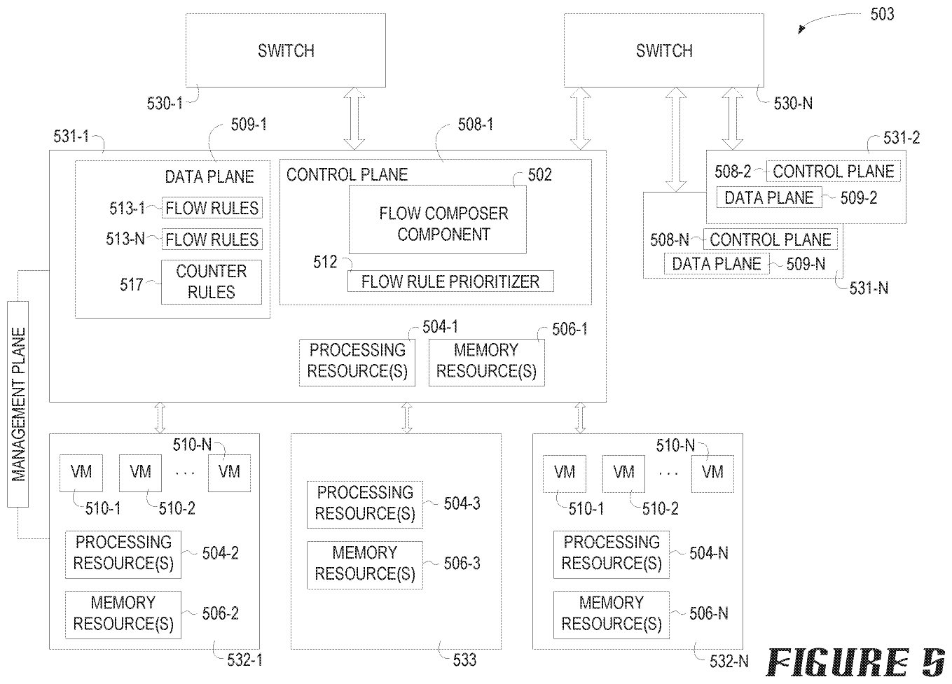

FIG. 3 illustrates a block diagram in the form of an example switching sub-system 307 consistent with the disclosure. The switching sub-system 307 illustrated in FIG. 3 includes a control plane 308 and a data plane 309. The control plane 308 can include a flow composer component 302 and a flow rule prioritizer 312. The data plane 309 can include flow rules 313-1, . . . , 313-N. In some examples, the data plane 309 can further include counter rules such as the counter rules 517 illustrated in FIG. 5, herein. Packets 314 can traverse a network fabric that includes traversing the data plane 309 and/or the control plane 308. Under normal high performance traffic flows, packets 314 traverse only the data plane 309, but flow rules currently in force in the data plane 309 may indicate a new or unknown flow and requires the packets 314 to be forward to the control plane 308, the flow rule prioritizer 312, and the flow composer 302 for flow identification, classification. The flow composer 302 may in turn modify the flow rule tables in the data plane 309 to enable future packets 314 belonging to a previously unidentified flow to now be forwarded directly by the data plane 309.

The flow rule prioritizer 312 can be a queue, register, or logic that can re-arrange an order in which the flow rules 313-1, . . . , 313-N can be executed. In some examples, the flow rule prioritizer 312 can operate as a packet 314 priority queue. In some examples, the flow rule prioritizer 312 can be configured to re-arrange application of the flow rules 313-1, . . . , 313-N in response to instructions received from the flow composer component 302.

The flow rules 313-1, . . . , 313-N of the data plane 309 can be stored in a flow rule data structure such as flow rule data structure 211 illustrated in FIG. 2D, herein. An example rule that can be stored in a TCAM rule table can be “copy a packet to the switching sub-system 307 (e.g., to the control plane 308 of the switching sub-system 307) if the packet is associated with any VLAN, any port, any MAC address, etc. of the network.”

An example listing of exact-match flow rules that can be included in the flow rules 313-1, . . . , 313-N follows. It is, however noted that the example listing of flow rules below is not limiting and flow rules can be added to the list, removed from the list, and/or performed in a different order than listed below. For example, the flow rule prioritizer 312 can operate to change the order of the flow rules, as described in more detail below.

1. Copy a packet to the switching sub-system 307 (e.g., to the control plane 308) if the packet is associated with a particular VLAN.
2. Copy a packet to the switching sub-system 307 if the packet is associated with the particular VLAN and has a first source MAC address associated therewith.
3. Don't copy a packet to the switching sub-system 307 if the packet is associated with the particular VLAN and has a first source MAC address associated therewith.
4. Copy a packet to the switching sub-system 307 if the packet is associated with the particular VLAN and has a second source MAC address associated therewith.
5. Don't copy a packet to the switching sub-system 307 if the packet is associated with the particular VLAN and has a second source MAC address associated therewith.
6. Copy a packet to the switching sub-system 307 if the packet is associated with the particular VLAN and has a first source MAC address and a second destination MAC address associated therewith.
7. Don't copy a packet to the switching sub-system 307 if the packet is associated with the particular VLAN and has a first source MAC address and a second destination MAC address associated therewith.
8. Don't copy a packet to the switching sub-system 307 if the packet is associated with the particular VLAN and has a second source MAC address and a first destination MAC address associated therewith.
9. Copy a packet to the switching sub-system 307 if the packet is associated with a first source IP, a second destination IP, and TCP transport protocol type and/or TCP destination port equal to a well-known value for an SSH endpoint value.
10. Don't copy a packet to the switching sub-system 307 if the packet is associated with a first source IP, a second destination IP, and TCP transport protocol type and/or first TCP destination port equal to a well know SSH endpoint and second TCP source port equal to a well-known SSH endpoint value.
11. Don't copy a packet to the switching sub-system 307 if the packet is associated with a first source IP, a second destination IP, and UDP protocol type.
12. Don't copy a packet to the switching sub-system 307 if the packet is associated with a first UDP source port and a second UDP destination port.

In some examples, the flow composer component 302 can cause flow rules to be stored (e.g., embedded) in the control plane 308 based, at least in part, on the type of rule, a resource type associated with the rule, or combinations thereof. These rules can then be used to construct flow rules to be applied to a data plane 309 of the switching sub-system 307. A non-limiting example using the above list of flow rules follows.

In the following example, the control plane 308 can cause the flow rules 313-1, . . . , 313-N to be stored in a flow rule data structure such as flow rule data structure 211 illustrated in FIG. 2 in the data plane 309, as indicated by the lines 315-1, . . . , 315-N. At the outset, rule #1 can have a lowest precedence associated therewith while rule #12 can have a higher precedence associated therewith. The flow rules 313-1, . . . , 313-N can be executed based on packet 314 metadata in the order shown above.

A particular flow can be detected using source and/or destination MAC addresses. For example, a L2 level flow that can be detected using source and/or destination MAC addresses may, as indicated by rules #7 and #8, not be resent to the control plane 308 once the flow is detected.

A different flow, for example a L4 level flow, may demand construction of one or more new flows on a given application between, for example, two IP address end points of the network. For example, in the listing of flow rules above rule #9 may be constructed to allow detection of multiple SSH flows between a first IP address and a second IP address. However, rule #10 prohibits duplicating the flow once detected. In this manner, examples described herein can operate to prevent duplicate flow rules from being copied to the control plane 308.

The flow rules 313-1, . . . , 313-N can be generated (e.g., constructed) automatically, for example, by flow composer 302 based on policy settings and/or based on metadata contained within the packet 314. Examples are not so limited, however, and the flow rules 313-1, . . . , 313-N can be generated dynamically by flow composer 302 or in response to one or more inputs and/or commands via management methods in the control plane 308. In some examples, the precedence of the flow rules 313-1, . . . , 313-N can be based on the type of rule and/or resources that may be used during the rule construction process.

As shown in FIG. 3, the control plane 308 can introduce the flow rules 313-1, . . . , 313-N to the data plane 309 via data paths 315-1, . . . , 315-N. The flow rules 313-1, . . . , 313-N can be introduced to the data plane 309 at any time during the rule construction process. For example, the control plane 308 can introduce the flow rules 313-1, . . . , 313-N to the data plane 309 immediately after a rule is constructed, at predetermined intervals, or in response to a request for flow rules 313-1, . . . , 313-N to be introduced to the control plane 309. In some examples, the control plane 308 can build, define, and/or store relationship data corresponding to the flow rules 313-1, . . . , 313-N. For example, in the above example list of flows, the control plane 308 may store a relationship between interdependent flow rules 313-1, . . . , 313-N such as rules #9, #10, and #11. In some examples, the control plane 308 may generate a flow as a result of detection of a L2 level entry in the flow rule data structure and in response storing additional rules in the flow rule data structure.

In some examples, if a flow is terminated (e.g., aborted), the corresponding set of flow rules 313-1, . . . , 313-N can be deleted from the flow rule data structure. For example, the flow rules 313-1, . . . , 313-N that correspond to flows that have been terminated can be deleted from the switching sub-system 307. Flows may be terminated in response to events generated by a L2 level table, other system tables, and/or in response to an action conducted by the control plane 308 as a result of one or more inputs and/or commands via management methods, or as a result of normal control plane protocol processing, or as a result of electrical changes in the switch system such as loss of signal or link down indication from one or more physical ports on the switch sub-system 307.

An example of the control plane 308 taking an action to terminate (or suspend) a flow can be based on flow statistics and/or a change in a state of the resource to which the flow corresponds. For example, in the above listing of rules, the first MAC address being removed could correspond to removal of rules #3, #6, #7, and #8.

In some examples, certain flow rules can be embedded into the flow rule data structure. These rules can serve to enable tracking counters for given flows, as well as track or determine various attributes of the flow rules 313-1, . . . , 313-N. In some examples, the control plane 308 can embed (e.g., store) these rules depending on the type of rules and/or attributes of the flow corresponding to the flow rules. For example, a L2 level flow may include attributes for a number of bytes corresponding to transmission packets and/or received packets, jumbo frames transmitted and/or received, etc., while a L3 level flow may include attributes corresponding to received and/or transmitted packet counts, etc.

In some examples, flow rules 313-1, . . . , 313-N can be created and/or deleted. For example, flow rules 313-1, . . . , 313-N can be created and/or deleted in response to application of counter rules (e.g., counter rules 517 illustrated and described in connection with FIG. 5, herein). In some examples, when a new flow rule 313-1, . . . , 313-N is created, an entry corresponding to the flow rule 313-1, . . . , 313-N can be generated in a system defined table such as a L2 level table or L3 level table, which may be generated at the data plane 309 and executed by the control plane 308.

In a non-limiting example, a current flow rule 313-1, . . . , 313-N (e.g., a flow rule that exists and is in use) can be defined such that packets 314 associated with a particular VLAN (e.g., a VLAN-100) are copied to the control plane 308 and packets 314 with a particular source address (e.g., a MAC source address aa:bb:cc:dd:ee:ff) are copied to the control plane 308. An associated counter rule (e.g., counter rule 517 illustrated in FIG. 5, herein) can include incrementing a flow rule counter corresponding to a broadcast packet count for the particular VLAN in response to the packets 314 associated with the particular VLAN being copied to the control plane 308.

If a packet 314 having a source MAC address of aa:bb:cc:ee:dd:ff and a destination MAC address of 11:22:33:44:55:66 is recieved, the packet 314 is copied of the control plane 308. In this example, because the packet 314 is copied to the control plane 308, a new rule may be generated to ensure that duplicate packets 314 are not copied to the control plane 308. For example, a new rule to not copy packets 314 with a source MAC address of aa:bb:cc:ee:dd:ff and destination MAC address 11:22:33:44:55:66 may be generated and added to the flow rules 313-1, . . . , 313-N.

In response to generation of the new flow rule 313-1, . . . , 313-N, a new counter rule may be generated. For example, a counter rule to increment the flow rule counter for packets 314 received and/or transmitted having a source MAC address of aa:bb:cc:dd:ee:ff and a destination MAC address of 11:22:33:44:55:66 may be generated and added to the counter rules.

The process of creating a new flow rule can include recognition of uni-directional, broadcast, and/or multicast packet 314 types. This may lead to a plurality of packets 314 being handled to create a new flow rule 313-1, . . . , 313-N. If a flow rule is created by the control plane 308, in some examples, user-defined tables and/or flow rule 313-1, . . . , 313-N entries may be created and/or stored in the data plane 309.

In some examples, flow rules 313-1, . . . , 313-N and/or flows can be deleted. When a flow rule 313-1, . . . , 313-N is deleted, corresponding flow rules 313-1, . . . , 313-N may also be deleted. In addition, as described in more detail in connection with FIG. 5, herein, counter rules (e.g., counter rules 517) corresponding to deleted flow rules 313-1, . . . , 313-N and/or flows may also be deleted.

The flow rules 313-1, . . . , 313-N can be subjected to packet-processing filters in order to apply the flow rules 313-1, . . . , 313-N to the rules in a “single pass” (e.g., at once without iteration). Packet-processing filters that may be used to process the flow rules 313-1, . . . , 313-N and/or the flows can include exact match handling (described above), ingress content aware processor (iCAP), egress content aware processor (eCAP), and/or virtual content aware processor (vCAP) filters.

FIG. 4 illustrates a block diagram in the form of an example system 403 including a flow composer component 402, a control plane 408, and a plurality of virtual machines (VMs) 410-1, . . . , 410-N. The system 403 can include processing resources 404 (e.g., a number of processors), and/or memory resources 406. The system 403 can be included in a software defined data center. A software defined data center can extend virtualization concepts such as abstraction, pooling, and automation to data center resources and services to provide information technology as a service (ITaaS). In a software defined data center, infrastructure, such as networking, processing, and security, can be virtualized and delivered as a service. A software defined data center can include software defined networking and/or software defined storage. In some embodiments, components of a software defined data center can be provisioned, operated, and/or managed through an application programming interface (API).

The VMs 410-1, . . . , 410-N can be provisioned with processing resources 404 and/or memory resources 406. The processing resources 404 and the memory resources 406 provisioned to the VMs 410-1, . . . , 410-N can be local and/or remote to the system 403. For example, in a software defined network, the VMs 410-1, . . . , 410-N can be provisioned with resources that are generally available to the software defined network and not tied to any particular hardware device. By way of example, the memory resources 406 can include volatile and/or non-volatile memory available to the VMs 410-1, . . . , 410-N. The VMs 410-1, . . . , 410-N can be moved to different hosts (not specifically illustrated), such that the VMs 410-1, . . . , 410-N are managed by different hypervisors.

In some examples, the flow composer component 402 can cause performance of actions based on flow rules (e.g., the flow rules 312-1, . . . , 312-N illustrated in FIG. 3, herein). In some examples, the flow composer component 402 can monitor which VMs 410-1, . . . , 410-N encounter particular traffic types based on application of the flow rules. Using this information, the flow composer component 402 can perform statistical analysis operations using information acquired in the process of monitoring execution of the flow rules. For example, the flow composer component 402 can determine that particular types of traffic are more likely, based on the statistical analysis operation, to traverse the network fabric through particular VMs of the VMs 410-1, . . . , 410-N.

Based on the statistical analysis, the flow composer component 402 can be configured to re-allocate resources (e.g., processing resource 404 and/or memory resources 406) to different VMs. This can improve performance of the system 403 and/or optimize resource allocation among the VMs 410-1, . . . , 410-N. Information corresponding to the statistical analysis operation and/or information corresponding to the reallocation of the resources amongst the VMs can be stored (e.g., by the memory resource 406) and/or displayed to a network admin via, for example, a graphical user interface.

FIG. 5 illustrates another a block diagram in the form of an example system 503 including a flow composer component 502, control planes 508-1, . . . , 508-N, and a plurality of virtual machines 510-1, . . . , 510-N. The system 503 can include processing resources 504-1, . . . , 504-N (e.g., a number of processors), and/or memory resources 506-1, . . . , 506-N. The system 503 can be analogous to the system 403 illustrated in FIG. 4, herein.

A plurality of switches 530-1, . . . , 530-N can be communicatively coupled to virtualization fabrics 531-1, . . . , 531-N. In some examples, the switches 530-1, . . . , 530-N can be top-of-rack switches. The virtualization fabrics 531-1, . . . , 531-N can be configured to provide movement of virtual machines (e.g., VMs 510-1, . . . , 510-N) between servers, such as blade servers, and/or virtual machines. A non-limiting example of a virtualization fabric 531-1, . . . , 531-N can be HEWLETT PACKARD VIRTUAL CONNECT®. In some examples, one or more of the virtualization fabrics (e.g., virtualization fabric 531-2 and virtualization fabric 531-N can be linked together such that they appear as a single logical unit.

The virtualization fabrics 531-1, . . . , 531-N can include respective control planes 508-1, . . . , 508-N and respective data planes 509-1, . . . , 509-N. As shown in FIG. 5, the virtualization fabric 531-1 can further include processing resource(s) 504-1 and/or memory resource(s) 506-1. Although not explicitly shown in FIG. 5, the virtualization fabrics 531-2, . . . , 531-N can also include processing resource(s) and/or memory resource(s).

The data planes 509-1, . . . , 509-N can include flow rules 513-1, . . . , 513-N as described in connection with FIG. 4, herein. In some examples, the data planes 509-1, . . . , 509-N can include counter rules 517. The counter rules 517 can include rules that govern incrementation of a flow execution counter in response to executing an action using the flow rules 513-1, . . . , 513-N. The flow execution counter can be used to track a quantity of times that a particular flow rule 513-1, . . . , 513-N has been executed. The counter rules 517 can cause a flow execution counter to be incremented each time an action is taken by the switching sub-system in relation to a particular flow rule 513-1, . . . , 513-N.

The counter rules 517 can be installed during an initialization process and/or may be generated against policy (e.g., may be policy based) during runtime. In some examples, flows and/or flow rules 513-1, . . . , 513-N can be created and/or deleted based on the counter rules 517. For example, the counter rules 517 may track detected flows and may be used to determine if flows and/or flow rules 513-1, . . . , 513-N are to be created or deleted. If a flow or flow rule 513-1, . . . , 513-N is deleted in response to a counter rule 517, the corresponding counter rule 517 may be deleted as well.

The control planes 508-1, . . . , 508-N can include a flow composer component 502 and/or a flow rule prioritizer 512. The flow rule prioritizer 512 can be a queue, register, or logic that can re-arrange an order in which the flow rules 513-1, . . . , 513-N can be executed. In some examples, the flow rule prioritizer 512 can operate as a packet priority queue. In some examples, the flow rule prioritizer 512 can be configured to re-arrange application of the flow rules 513-1, . . . , 513-N in response to instructions received from the flow composer component 508.

The virtualization fabric 531-1 can be communicatively coupled to virtualized servers 532-1, . . . , 532-N and/or a bare metal server 533 via, for example, a management plane. In some examples, the management plane can configure, monitor, and/or manage layers of the network.

The bare metal server 533 can include processing resource(s) 504-3 and/or memory resources 506-3. The bare metal server 533 can be a physical server, such as a single-tenant physical server.

The virtualized servers 532-1, . . . , 532-N can include processing resource(s) 504-2/504-N and/or memory resources 506-2/506-N that can provision VMs 510-1, . . . , 510-N that are associated therewith. The VMs 510-1, . . . , 510-N can be analogous to the VMs 410-1, . . . , 410-N described above in connection with FIG. 4.

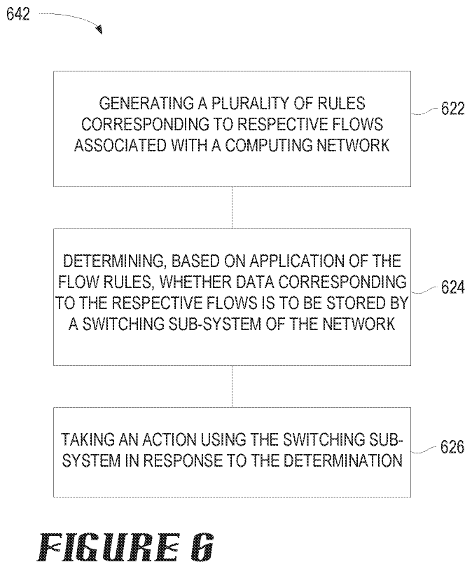

FIG. 6 illustrates an example flow diagram 642 for flow rules consistent with the disclosure. At block 622, a method for application of flow rules can include generating a plurality of rules corresponding to respective flows associated with a computing network. The flow rules can be analogous to the flow rules 313-1, . . . , 313-N illustrated in FIG. 3 and/or flow rules 513-1, . . . , 513-N illustrated in FIG. 5, herein. The flow rules can be generated by a switching sub-system (e.g., by a flow composer component such as flow composer component 202 illustrated in FIGS. 2A-2D). As discussed herein, the flow rules can correspond to network rules, media access control rules, internet protocol rules, transmission control protocol rules, secure socket shell rules, packet processing rules, or combinations thereof, etc.

At block 642, the method can include determining, based on application of flow rules, whether data corresponding to the respective flows is to be stored by a switching sub-system of the network. The switching sub-system can be analogous to the switching sub-system 307 illustrated in FIG. 3, herein.

At block 644, the method can include taking an action using the switching sub-system in response to the determination. The action can include copying (or not copying) the flow rules to a control plane of the switching sub-system, re-arranging application of the flow rules, deleting one or more flow rules, performing a statistical analysis operation using the flow rules, etc., as supported by the disclosure.

For example, the method can include determining that a first respective flow has a higher priority than a second respective flow and executing the action by processing the first respective flow prior to processing the second respective flow. In some examples, the second respective flow was, prior to the determination that the first respective flow has the higher priority, scheduled to be executed prior to the first respective flow. Stated alternatively, application of the flow rules can be dynamically altered or changed.

In some examples, the method can include incrementing a flow execution counter in response to executing the action. The flow execution counter can be used to track a quantity of times that a particular flow rule has been executed. For example, the flow execution counter can be incremented each time an action is taken by the switching sub-system in relation to a particular flow rule. This can allow for statistical analysis to be performed to determine which flow rules are executed more frequently than others, which flow rules involve particular network resources, etc.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure. As used herein, designators such as “N”, etc., particularly with respect to reference numerals in the drawings, indicate that a number of the particular feature so designated can be included. A “plurality of” is intended to refer to more than one of such things. Multiple like elements may be referenced herein by their reference numeral without a specific identifier at the end.

The figures herein follow a numbering convention in which the first digit corresponds to the drawing figure number and the remaining digits identify an element or component in the drawing. For example, reference numeral 102 may refer to element “02” in FIG. 1 and an analogous element may be identified by reference numeral 202 in FIG. 2. Elements shown in the various figures herein can be added, exchanged, and/or eliminated so as to provide a number of additional examples of the disclosure. In addition, the proportion and the relative scale of the elements provided in the figures are intended to illustrate the examples of the disclosure, and should not be taken in a limiting sense.

What is claimed:

1. A method, comprising:
generating a plurality of rules corresponding to respective flows associated with a computing network;
determining, based on application of flow rules, whether data corresponding to the respective flows is to be stored by a switching sub-system of the network; and
taking an action using the switching sub-system in response to the determination.

2. The method of claim 1, wherein the flow rules include rules corresponding to network rules, media access control rules, internet protocol rules, transmission control protocol rules, secure socket shell rules, packet processing rules, or combinations thereof.

3. The method of claim 1, wherein determining whether data is to be stored by the switching sub-system further comprises determining that the data is to be copied to the switching sub-system or determining that the data is not to be copied to the switching sub-system.

4. The method of claim 1, further comprising:
determining that a first respective flow has a higher priority than a second respective flow; and
executing the action by processing the first respective flow prior to processing the second respective flow.

5. The method of claim 4, wherein the second respective flow was, prior to the determination that the first respective flow has the higher priority, scheduled to be executed prior to the first respective flow.

6. The method of claim 1, further comprising incrementing a flow execution counter in response to executing the action.

7. The method of claim 6, further comprising:
determining that the counter has reached a threshold count value; and
provisioning a virtual machine associated with the network with resources based, at least in part, on the determination that the counter has reached the threshold value.

8. The method of claim 1, further comprising performing a statistical analysis operation on at least one respective flow to determine characteristics of the at least one respective flow.

9. An apparatus, comprising:
a flow composer component provisioned with a processing resource and a memory resource, the flow composer component to:
cause generation of a flow rule data structure;
cause the flow rule data structure to be populated with flow rules corresponding to respective switching sub-system flows; and
cause an action to be performed using a switching sub-system based, at least in part, on the respective flow rules.

10. The apparatus of claim 9, wherein the flow composer component is to cause performance of a flow rule prioritization operation to set an order in which the action is performed on the respective flow rules.

11. The apparatus of claim 10, wherein the flow composer component is to:
cause performance of a flow prioritization operation; and
alter the order in which the action is performed based, at least in part, on performance of the flow prioritization operation.

12. The apparatus of claim 9, wherein the action comprises an action to copy a flow to a control plane of the switching sub-system.

13. The apparatus of claim 9, wherein the action comprises an action to not copy the flow to a control plane of the switching sub-system.

14. The apparatus of claim 9, wherein the flow composer component is to increment a flow execution counter in response to performance of the action.

15. The apparatus of claim 14, wherein the flow composer component is to cause performance of a statistical analysis operation using information corresponding to at least one flow and information corresponding to the flow execution counter.

16. A system, comprising:
a software defined network comprising:
a plurality of virtual machines provisioned with processing and memory resources;
a control plane; and
a flow composer component provisioned with hardware and memory resources, wherein the flow composed component is to:
cause an action corresponding to each of a plurality of flows to be performed using the control plane based, at least in part, on application of flow rules to each flow of the plurality of flows;
perform a statistical analysis operation on the flows to determine characteristics of the flows; and
alter an amount of processing or memory resources provisioned to at least one virtual machine based, at least in part, on the determined characteristics of the flows.

17. The system of claim 16, wherein the flow composer component is to cause the flow rules to be ranked based, at least in part, on an order in which the action corresponding to respective flows among the plurality of flows is to be performed.

18. The system of claim 17, wherein the flow composer component is to alter the order in which the flow rules are ranked based, at least in part, on performance of a flow prioritization operation.

19. The system of claim 16, wherein the action comprises at least one of an action to copy at least one flow among the plurality of flows to the control plane and an action to not copy the at least one flow among the plurality of flows to the control plane.

20. The system of claim 16, wherein the flow composer component is to cause information corresponding to the virtual machines, the flow rules, the statistical analysis operation, or combinations thereof to be displayed via a graphical user interface.
